(19) United States
(12) Patent Application Publication
(10) Pub. No.: US 2015/0205454 A1
(43) Pub. Date: Jul. 23, 2015

(54) SYSTEMS AND METHODS FOR DISPLAYING PREVIEW DATA

(71) Applicants: Alex Neely AINSLIE, San Francisco, CA (US); Theodore Nicholas CHOC, Palo Alto, CA (US)

(72) Inventors: Alex Neely AINSLIE, San Francisco, CA (US); Theodore Nicholas CHOC, Palo Alto, CA (US)

(73) Assignee: GOOGLE INC., Mountain View, CA (US)

(21) Appl. No.: 13/347,634

(22) Filed: Jan. 10, 2012

(51) Int. Cl. G06F 3/0482; H04L 29/08; G06F 3/0485; G06F 3/0481; G06F 3/0484

(52) U.S. Cl. CPC G06F 3/0482; G06F 3/04817; G06F 3/04842; G06F 3/0485; H04L 67/02

(57) ABSTRACT

Systems and methods for displaying preview data on an electronic device are provided. In some aspects, a method includes providing for display source content on the electronic device. The source content includes an access point configured to link to target content. The target content is provided by a host that is remote from the electronic device. The method also includes receiving input from a user for accessing the target content via the access point, and obtaining preview data of the target content in response to the user input. The preview data is obtained prior to a connection being established between the electronic device and the host of the target content. The method also includes providing for display a stack of items on the electronic device. At least one of the stack of items comprises the preview data of the target content.

### FIELD

The subject technology generally relates to displaying data and, in particular, relates to systems and methods for displaying preview data on an electronic device.

### BACKGROUND

When a user is viewing a particular webpage with a web browser, the user may find a link on the webpage that provides access to content that the user desires to view. However, the user may also wish to remain viewing the particular webpage. In this regard, the user may open the desired content in the background (e.g., using another tab or another window of the web browser). Opening the desired content in the background may involve retrieving the content and/or rendering the content in the background. However, if the user later decides not to view the content anymore, resources (e.g., in terms of processing and/or bandwidth) may be wasted in retrieving and/or rendering the content in the background. Thus, preview data of the desired content may be beneficially used to provide the user with a preview of what the desired content is without necessarily having to fully retrieve and/or render the desired content.

### SUMMARY

According to various aspects of the subject technology, a computer-implemented method for displaying preview data on an electronic device is provided. The method comprises providing for display source content on the electronic device. The source content comprises an access point configured to link to target content. The target content is provided by a host that is remote from the electronic device. The method also comprises receiving input from a user for accessing the target content via the access point, and obtaining preview data of the target content in response to the user input. The preview data is obtained prior to a connection being established between the electronic device and the host of the target content. The method also comprises providing for display a stack of items on the electronic device. At least one of the stack of items is overlaid on top of another of the stack of items. At least one of the stack of items comprises the preview data of the target content.

According to various aspects of the subject technology, a system for displaying preview data on an electronic device is provided. The system comprises a display module configured to provide for display source content on the electronic device. The source content comprises an access point configured to link to target content. The target content is provided by a host that is remote from the electronic device. The system also comprises a detection module configured to receive input from a user for accessing the target content via the access point. The system also comprises a preview module configured to obtain preview data of the target content in response to the user input. The preview data is obtained prior to a connection being established between the electronic device and the host of the target content. The display module is configured to provide for display a stack of items on the electronic device. At least one of the stack of items is overlaid on top of another of the stack of items. At least one of the stack of items comprises the preview data of the target content.

According to various aspects of the subject technology, a machine-readable medium encoded with executable instructions for displaying preview data on an electronic device is provided. The instructions comprise code for providing for display source content on the electronic device. The source content comprises an access point configured to link to target content. The target content is provided by a host that is remote from the electronic device. The instructions also comprise code for receiving input from a user for accessing the target content via the access point. The instructions also comprise code for obtaining preview data of the target content in response to the user input. The preview data is obtained prior to a connection being established between the electronic device and the host of the target content. The connection is configured to facilitate the transfer of the target content from the host to the electronic device. The instructions also comprise code for providing for display a stack of items on the electronic device. At least one of the stack of items is overlaid on top of another of the stack of items. At least one of the stack of items comprises the preview data. The instructions also comprise code for allowing the user to select the at least one of the stack of items comprising the preview data of the target content. The instructions also comprise code for obtaining the target content in response to the selection of the at least one of the stack of items comprising the preview data. The instructions also comprise code for providing for display the target content on the electronic device.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 illustrates an example of a system for displaying preview data on an electronic device, in accordance with various aspects of the subject technology.

FIG. 2 illustrates an example of a method for displaying preview data on an electronic device, in accordance with various aspects of the subject technology.

FIGS. 3A and 3B illustrate an example of a stack of items displayed on a screen of an electronic device, in accordance with various aspects of the subject technology.

FIG. 4 illustrates an example of preview data, in accordance with various aspects of the subject technology.

FIG. 5 illustrates an example of preview data, in accordance with various aspects of the subject technology.

FIG. 6 illustrates an example of preview data, in accordance with various aspects of the subject technology.

FIG. 7 is a block diagram illustrating components of a controller, in accordance with various aspects of the subject technology.

### DETAILED DESCRIPTION

In the following detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

Mobile devices such as smartphones and tablet computers are typically equipped with small screens compared to other computing devices like laptop computers and desktop computers. In this regard, a stacking mode may be employed in which items displayed on the mobile devices can be stacked on top of one another in order to save space and accommodate the smaller screens. Items that may be stacked include windows, browser tabs, contact pages, documents, images, and other suitable items in a frame format. For example, a mobile device may display multiple windows stacked on top of one another, and a user may select a particular window to be displayed by rearranging the stack of multiple windows or manipulating the stack in some other manner. U.S. patent application Ser. No. 13/094,489, filed on Apr. 26, 2011 and entitled “Mobile Browser Context Switching,” describes various examples of stacked items and is incorporated by reference herein.

According to various aspects of the subject technology, at least one of the stack of items may be used to display preview data of content that a user desires to access. For example, the user may be viewing a particular webpage using a web browser of the mobile device, and may find a link on the webpage that provides access to content that the user desires to view (e.g., target content). The user may select the link to open the target content in the background. According to certain aspects, preview data of the target content may be obtained and displayed as at least one of the stack of items in the stacking mode. A size of the preview data may be less than a size of the target content itself. Furthermore, the preview data may be displayed prior to the full target content being displayed. Thus, if the user later decides not to view the target content anymore, resources (e.g., in terms of processing and/or bandwidth) may be conserved because the full target content may not need to be retrieved and/or rendered. While the preview data is described as being displayed on a mobile device, the preview data may also be displayed on any suitable electronic device, such as a desktop computer, a laptop computer, a tablet computer, a mobile phone, and a personal digital assistant.

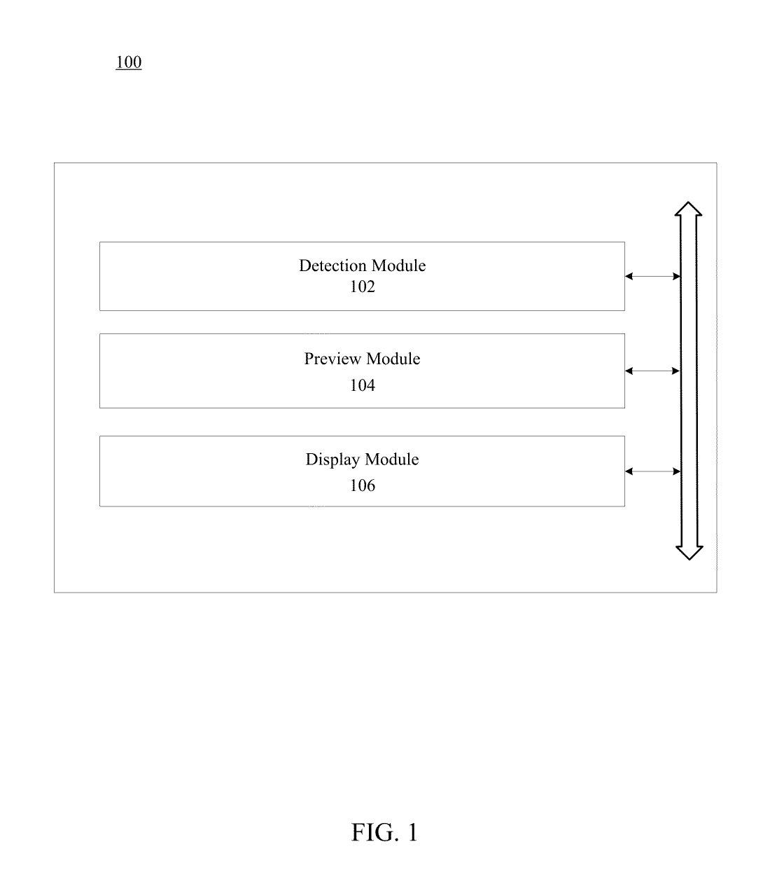

FIG. 1 illustrates an example of system 100 for displaying preview data on an electronic device, in accordance with various aspects of the subject technology. System 100 comprises detection module 102, preview module 104, and display module 106. These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

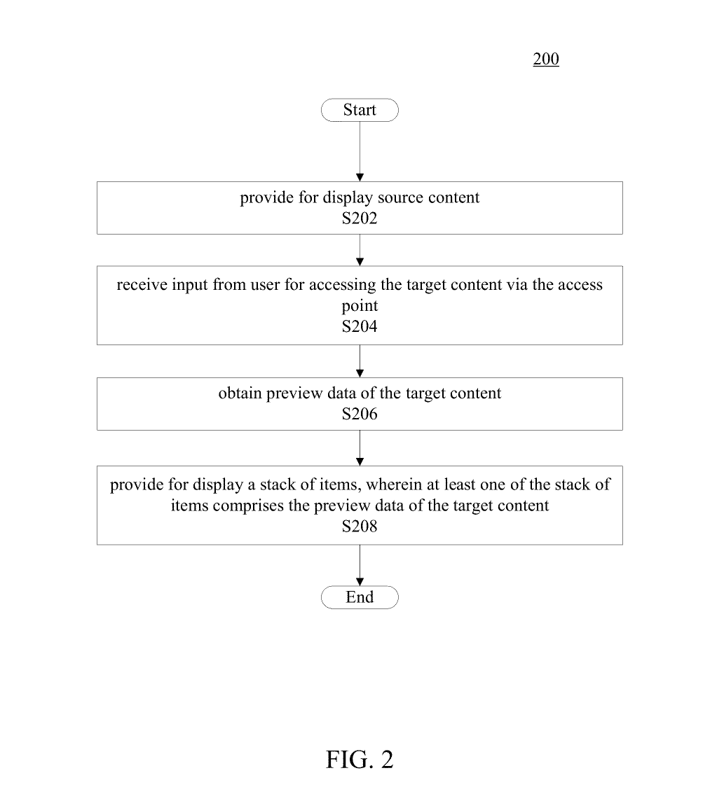

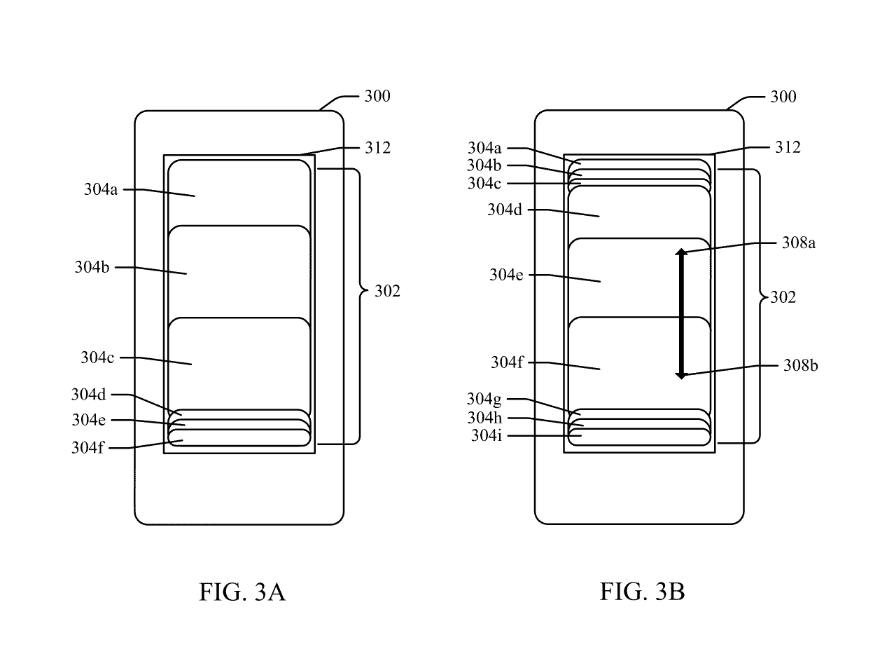

FIG. 2 illustrates an example of method 200 for displaying preview data on an electronic device, in accordance with various aspects of the subject technology. Method 200, for example, may be implemented by system 100 to display the preview data using a stack of items. FIG. 3A illustrates an example of a stack of items 302 displayed on screen 312 of electronic device 300, in accordance with various aspects of the subject technology. Stack of items 302 comprises items 304a, 304b, 304c, 304d, 304e, and 304f. At least one of the stack of items is overlaid on top of another of the stack of items. Each of the items displayed may comprise at least one of a window, a browser tab, a contact page, a document, an image, and other suitable content in a frame format. For example, each of the items may display different preview data associated with different target content. Items 304a, 304b, and 304c are shown in FIG. 3A in an expanded state compared to items 304d, 304e, and 304f. For example, each of the expanded items (e.g., items 304a, 304b, and 304c) displays more content than a collapsed one of the unexpanded stack of items (e.g., items 304d, 304e, and 304f).

According to various aspects of the subject technology, the stack of items 302 may be visually scrolled through such that one or more of the stack of items 302 may be expanded in order to allow a user of electronic device 300 to view the content of the expanded items. For example, stack of items 302 may be visually scrolled in the direction of arrow 308a or arrow 308b, as shown in FIG. 3B. According to certain aspects, stack of items 302 may be visually scrolled through by expanding one or more of stack of items 302. For example, FIG. 3B illustrates electronic device 300 after the stack of items 302 has been visually scrolled through in the direction of arrow 308a compared to electronic device 300 in FIG. 3A. Compared to items 304a, 304b, and 304c in FIG. 3A, these items in FIG. 3B are scrolled in the direction of arrow 308a and collapsed into an unexpanded state at a top of screen 312. Furthermore, while items 304d, 304e, and 304f are collapsed in an unexpanded state in FIG. 3A, these items are scrolled in the direction of arrow 308a and expanded as shown in FIG. 3B. As a result of items 304d, 304e, and 304f being expanded in the direction of arrow 308a, new items (e.g., items 304g, 304h, and 304i) are revealed as part of the stack of items 302.

Returning to FIGS. 1 and 2, according to step S202, display module 106 may provide for display source content on electronic device 300. The source content may be a webpage, text data, image data, audio data, video data, and/or other content that the user is viewing using electronic device 300. The source content may comprise an access point configured to link to target content, which may be provided by a host that is remote from electronic device 300. According to step S204, detection module 102 may receive input from the user for accessing the target content via the access point. The user input, for example, may indicate that the user desires to access the target content in the background via the access point. The target content may be a webpage, text data, image data, audio data, video data, and/or other suitable content. The access point may be a link (e.g., a hyperlink), a bookmark, and/or another suitable access point for providing access to the target content. For example, as discussed above, the user may be viewing particular source content like a webpage using a web browser of electronic device 300, and may find a link on the webpage that provides access to the target content that the user desires to view. The user may select the link to open the target content in the background.

According to step S206, preview module 104 may obtain preview data of the target content in response to the user input. In some aspects, the preview data may be obtained without having to establish a connection between electronic device 300 and the host of the target content. For example, the preview data may be obtained prior to the connection being established between electronic device 300 and the host of the target content. This connection, for example, may be used to facilitate the transfer of the target content from the host to electronic device 300. However, the preview data may be obtained without having to rely on this connection, which may be beneficial for conserving resources (e.g., in terms of processing and/or bandwidth) especially if the user later decides not to view the target content anymore.

According to step S208, display module 106 may provide for display a stack of items on electronic device 300, wherein at least one of the stack of items comprises the preview data of the target content. For example, at least one of items 304a, 304b, 304c, 304d, 304e, 304f, 304g, 304h, and 304i in FIGS. 3A and 3B may comprise the preview data of the target content. The stack of items may allow the user to select at least one of the items comprising the preview data for display. Once selected, the target content may be obtained (e.g., by establishing the connection between electronic device 300 and the host of the target content, and then retrieving the target content from the host using the connection). Display module 106 may then display the target content on electronic device 300 (e.g., replacing the source content with the target content).

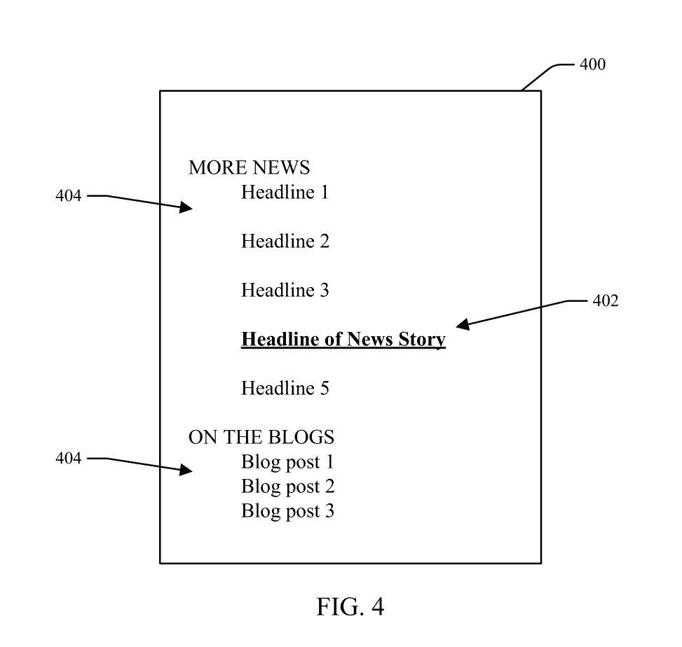

According to various aspects of the subject technology, several approaches may be employed for obtaining the preview data. In some aspects, preview module 104 may generate the preview data by using at least a portion of the source content that contains the access point. This source content, for example, may be the webpage, or some other suitable content, that contains a link to the target content. FIG. 4 illustrates an example of preview data 400 generated using at least a portion of the source content, in accordance with various aspects of the subject technology. Preview data 400 comprises a portion of the source content that contains access point 402 (e.g., a screenshot of the source content containing access point 402). As shown in FIG. 4, the source content is a news webpage that contains various links, such as access point 402. Preview data 400 comprises a portion of the source content containing access point 402, which is a hyperlink with the title, “Headline of News Story.” Preview data 400 also comprises area 404, which is another portion of the source content and is adjacent to and/or surrounding access point 402. Including area 404 as part of preview data 400 may provide the user with some context as to how access point 402 is displayed in the source content. For example, as shown in FIG. 4, area 404 comprises headlines of other articles (e.g., headlines 1, 2, 3, and 5) and various blog posts (e.g., blog posts 1, 2, and 3). Other suitable contextual data similar to area 404 in the form of image, text, and/or video data may be used to provide the user with the context of how access point 402 is displayed as part of the source content.

According to certain aspects, access point 402 and/or area 404 may be modified to allow access point 402 to visually stand out relative to area 404. For example, access point 402 may be highlighted, underlined, italicized, and/or bolded relative to area 404. In some aspects, area 404 may be blurred and/or faded relative to access point 402. For example, area 404 may be spaced at a predetermined distance from access point 402. Thus, any area spaced at least as far as the predetermined distance from access point 402 may be blurred and/or faded in order to allow access point 402 to visually stand out.

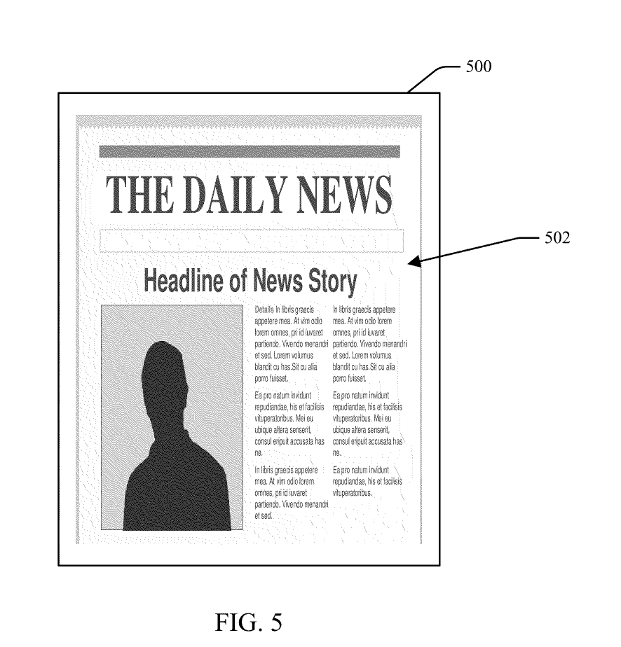

According to various aspects of the subject technology, the preview data for the target content may also be obtained from a server that generates different preview data for webpages. For example, the server may generate preview images of various webpages (e.g., screenshots of the webpages as preview images), and may be different from the host of the target content. In this regard, preview module 104 may transmit a request to the server for preview data of the target content, and receive the preview data from the server in response to the request. The request, for example, may comprise a uniform resource locator associated with the target content. The server, for example, may provide the preview data in the form of a screenshot of the target content. FIG. 5 illustrates an example of preview data 500 received from a server, in accordance with various aspects of the subject technology. Preview data 500 comprises a screenshot 502 of the target content, which in this case is a webpage from the host, “The Daily News,” and contains an article with the headline, “Headline of News Story.” According to certain aspects, screenshot 502 may be a mobile-specific version of the target content.

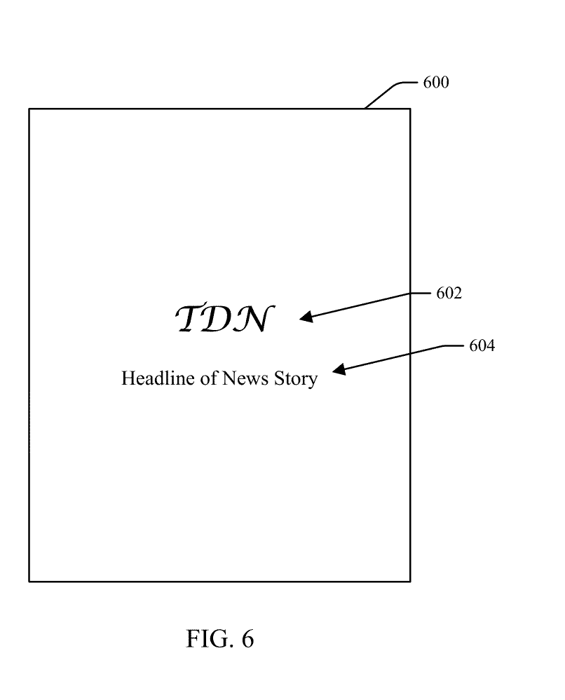

According to various aspects of the subject technology, preview module 104 may also obtain the preview data by using an icon (e.g., a favicon) or some other identification information associated with the host of the target content. For example, if the target content is a webpage, the preview data may comprise a favicon of the host of the webpage. FIG. 6 illustrates an example of preview data 600 that comprises identification information associated with a host of the target content, in accordance with various aspects of the subject technology. In continuing with the example in FIG. 5, preview data 600 in FIG. 6 comprises icon 602, which is a favicon of the host of the target content, “The Daily News.” According to certain aspects, preview data 600 may also comprise other information for identifying the target content itself. In this case, preview data 600 comprises headline 604, which is the headline of the target content. According to certain aspects, preview data 600 may comprise at least one of an icon representing the host, text data associated with the target content, image data associated with the target content, video data associated with the target content, and other suitable information for identifying the host of the target content and/or the target content itself.

Icon 602, or other suitable identification information of the host, may be obtained from the host itself or from the memory of electronic device 300 (if the host was previously accessed by the user). For example, detection module 102 may determine if the host of the target content was previously accessed using electronic device 300. If the host of the target content was previously accessed, then preview module 104 may generate icon 602 (e.g., retrieve icon 602 from the memory of electronic device 300). In some aspects, preview module 104 may receive preview data 600 from the host of the target content itself. For example, preview module 104 may transmit a request to the host of the target content for preview data 600, and may receive preview data 600 from the host in response to the request.

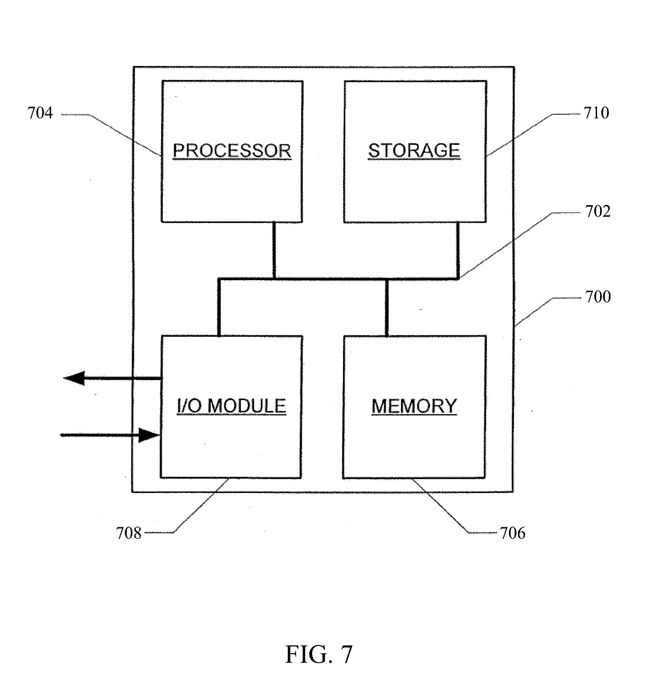

FIG. 7 is a block diagram illustrating components of controller 700, in accordance with various aspects of the subject technology. Controller 700 comprises processor module 704, storage module 710, input/output (I/O) module 708, memory module 706, and bus 702. Bus 702 may be any suitable communication mechanism for communicating information. Processor module 704, storage module 710, I/O module 708, and memory module 706 are coupled with bus 702 for communicating information between any of the modules of controller 700 and/or information between any module of controller 700 and a device external to controller 700. For example, information communicated between any of the modules of controller 700 may include instructions and/or data. In some aspects, bus 702 may be a universal serial bus. In some aspects, bus 702 may provide Ethernet connectivity.

In some aspects, processor module 704 may comprise one or more processors, where each processor may perform different functions or execute different instructions and/or processes. For example, one or more processors may execute instructions for displaying preview data on an electronic device (e.g., method 200) and one or more processors may execute instructions for input/output functions.

Memory module 706 may be random access memory (“RAM”) or other dynamic storage devices for storing information and instructions to be executed by processor module 704. Memory module 706 may also be used for storing temporary variables or other intermediate information during execution of instructions by processor 704. In some aspects, memory module 706 may comprise battery-powered static RAM, which stores information without requiring power to maintain the stored information. Storage module 710 may be a magnetic disk or optical disk and may also store information and instructions. In some aspects, storage module 710 may comprise hard disk storage or electronic memory storage (e.g., flash memory). In some aspects, memory module 706 and storage module 710 are both a machine-readable medium.

Controller 700 is coupled via I/O module 708 to a user interface for providing information to and receiving information from an operator of system 100. For example, the user interface may be a cathode ray tube (“CRT”) or LCD monitor for displaying information to an operator. The user interface may also include, for example, a keyboard or a mouse coupled to controller 700 via I/O module 708 for communicating information and command selections to processor module 704.

According to various aspects of the subject disclosure, methods described herein are executed by controller 700. Specifically, processor module 704 executes one or more sequences of instructions contained in memory module 706 and/or storage module 710. In one example, instructions may be read into memory module 706 from another machine-readable medium, such as storage module 710. In another example, instructions may be read directly into memory module 706 from I/O module 708, for example from an operator of system 100 via the user interface. Execution of the sequences of instructions contained in memory module 706 and/or storage module 710 causes processor module 704 to perform methods to display preview data on an electronic device. For example, a computational algorithm for displaying preview data on an electronic device may be stored in memory module 706 and/or storage module 710 as one or more sequences of instructions. Information such as the user input, the target content, the access point, the stack of items, the preview data, the predetermined distance, the request to the server, the request to the host, and/or other suitable information may be communicated from processor module 704 to memory module 706 and/or storage module 710 via bus 702 for storage. In some aspects, the information may be communicated from processor module 704, memory module 706, and/or storage module 710 to I/O module 708 via bus 702. The information may then be communicated from I/O module 708 to an operator of system 100 via the user interface.

One or more processors in a multi-processing arrangement may also be employed to execute the sequences of instructions contained in memory module 706 and/or storage module 710. In some aspects, hard-wired circuitry may be used in place of or in combination with software instructions to implement various aspects of the subject disclosure. Thus, aspects of the subject disclosure are not limited to any specific combination of hardware circuitry and software.

The term “machine-readable medium,” or “computer-readable medium,” as used herein, refers to any medium that participates in providing instructions to processor module 704 for execution. Such a medium may take many forms, including, but not limited to, non-volatile media and volatile media. Non-volatile media include, for example, optical or magnetic disks, such as storage module 710. Volatile media include dynamic memory, such as memory module 706. Common forms of machine-readable media or computer-readable media include, for example, floppy disk, a flexible disk, hard disk, magnetic tape, any other magnetic medium, a CD-ROM, DVD, any other optical medium, punch cards, paper tape, any other physical mediums with patterns of holes, a RAM, a PROM, an EPROM, a FLASH EPROM, any other memory chip or cartridge, or any other medium from which a processor can read.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

1. A computer-implemented method for displaying preview data on an electronic device, the method comprising:
providing for display source content on the electronic device, the source content comprising an access point configured to link to target content, the target content being provided by a host that is remote from the electronic device;
receiving input from a user for accessing the target content via the access point;
obtaining preview data of the target content in response to the user input, wherein the preview data corresponds to an icon for identifying the host of the target content or to a screenshot corresponding to the target content, and wherein the preview data is obtained from a source separate from the host of the target content; and
providing for display a stack of items on the electronic device, wherein at least one item of the stack of items is overlaid on top of another item of the stack of items, and wherein at least one item of the stack of items comprises the preview data of the target content.

2. The method of claim 1, further comprising:
allowing the user to select the at least one item of the stack of items comprising the preview data;
obtaining the target content in response to the selection of the at least one item of the stack of items comprising the preview data; and
providing for display the target content on the electronic device.

3. The method of claim 2, wherein obtaining the target content comprises establishing the connection between the electronic device and the host of the target content.

4. The method of claim 2, wherein the preview data is obtained prior to a connection being established between the electronic device and the host of the target content.

5. The method of claim 1, wherein the connection is established to transfer the target content from the host to the electronic device.

6. The method of claim 1, wherein the preview data is obtained without having to establish the connection between the electronic device and the host of the target content.

7. The method of claim 1, wherein the access point comprises at least one of a hyperlink and a bookmark.

8. The method of claim 1, wherein each of the source content and the target content comprises at least one of a webpage, text data, image data, audio data, and video data.

9. The method of claim 1, wherein each of the stack of items comprises at least one of a window, a browser tab, a contact page, a document, and an image.

10. The method of claim 1, further comprising generating the preview data in response to the user input.

11. The method of claim 1, wherein the preview data comprises at least a portion of the source content.

12. The method of claim 11, wherein the at least a portion of the source content comprises at least one of an image of the access point and contextual data associated with the access point.

13. The method of claim 12, wherein the image of the access point is highlighted, underlined, italicized, and/or bolded relative to the contextual data.

14. The method of claim 12, wherein the contextual data is blurred and/or faded relative to the image of the access point.

15. The method of claim 12, wherein the contextual data comprises at least one of text data and image data adjacent to and/or surrounding the access point.

16. The method of claim 12, wherein the contextual data comprises an area adjacent to and/or surrounding the access point.

17. The method of claim 16, wherein the area is spaced at a predetermined distance from the access point.

18. The method of claim 1, further comprising transmitting a request to a server for the preview data, and receiving the preview data from the server in response to the request, wherein the server is different from the host of the target content.

19. The method of claim 18, wherein the request comprises a uniform resource locator associated with the target content.

20. The method of claim 1, wherein the preview data comprises a screenshot of the target content.

21. The method of claim 1, further comprising determining if the host of the target content was previously accessed using the electronic device.

22. The method of claim 21, further comprising generating the preview data if the host of the target content was previously accessed, the preview data comprising an icon representing the host.

23. A system for displaying preview data on an electronic device, the system comprising:
one or more processors; and
a machine readable storage device or memory comprising instructions stored therein, which when executed by the one or more processors, cause the processors to perform operations including:
providing for display source content on the electronic device, the source content comprising an access point configured to link to target content, the target content being provided by a host that is remote from the electronic device;
receiving input from a user for accessing the target content via the access point; and
obtaining preview data of the target content in response to the user input, wherein the preview data corresponds to an icon for identifying the host of the target content or to a screenshot corresponding to the target content, and wherein the preview data is obtained from a source separate from the host of the target content; and
providing for display a stack of items on the electronic device,
wherein at least one item of the stack of items is overlaid on top of another item of the stack of items, and
wherein at least one item of the stack of items comprises the preview data of the target content.

24. The system of claim 23, wherein the preview data is obtained in response to the user input.

25. The system of claim 23, wherein obtaining the preview data further comprises transmitting a request to a server for the preview data and receiving the preview data from the server in response to the request, wherein the request comprises a uniform resource locator associated with the target content, and wherein the server is different from the host of the target content.

26. The system of claim 23, wherein the operations further comprise determining if the host of the target content was previously accessed using the electronic device, and generating the preview data if the host of the target content was previously accessed, wherein the preview data comprises an icon representing the host.

27. A non-transitory machine-readable medium encoded with executable instructions for displaying preview data on an electronic device, the instructions comprising code for:
providing for display source content on the electronic device, the source content comprising an access point configured to link to target content, the target content being provided by a host that is remote from the electronic device;
receiving input from a user for accessing the target content via the access point;
obtaining preview data of the target content in response to the user input, wherein the preview data corresponds to an icon for identifying the host of the target content or to a screenshot corresponding to the target content, and wherein the preview data is obtained from a source separate from the host of the target content, wherein the connection is established to transfer the target content from the host to the electronic device;
providing for display a stack of items on the electronic device, wherein at least one item of the stack of items is overlaid on top of another item of the stack of items, and wherein at least one item of the stack of items comprises the preview data;
allowing the user to select the at least one item of the stack of items comprising the preview data of the target content;
obtaining the target content in response to the selection of the at least one item of the stack of items comprising the preview data; and
providing for display the target content on the electronic device.

28. The non-transitory machine-readable medium of claim 27, wherein obtaining the preview data comprises generating the preview data, the preview data comprising at least a portion of the source content, the at least a portion of the source content comprising at least one of an image of the access point and contextual data associated with the access point.

29. The non-transitory machine-readable medium of claim 28, wherein the image of the access point is highlighted, underlined, italicized, and/or bolded relative to the contextual data.

30. The method of claim 1, further comprising:
receiving input from the user for scrolling through the stack of items; and
providing for expanding at least one item of the stack of items, in response to the user input for scrolling through the stack of items, wherein the expanding displays more content for the at least one item relative to other items in the stack of items.
